(19) United States
(12) Patent Application Publication
(10) Pub. No.: US 2021/0065068 A1
(43) Pub. Date: Mar. 4, 2021

(54) TRAVEL PLAN PROPOSITION APPARATUS AND TRAVEL PLAN PROPOSITION METHOD FOR A TRAVEL PLAN PROPOSITION APPARATUS

(71) Applicant: TOSHIBA TEC KABUSHIKI KAISHA, Tokyo (JP)

(72) Inventor: Shinichi SHIMOIRISA, Mishima Shizuoka (JP)

(21) Appl. No.: 16/912,564

(22) Filed: Jun. 25, 2020

(30) Foreign Application Priority Data
Sep. 2, 2019 (JP) 2019-159652

(51) Int. Cl. G06Q 10/02; G06Q 50/14; G06F 16/9535; G06F 16/9532

(52) U.S. Cl. CPC G06Q 10/02; G06F 16/9532; G06F 16/9535; G06Q 50/14

(57) ABSTRACT

In accordance with an embodiment, a travel plan proposition apparatus includes a storage device and a processor. The processor performs determination of a question about a travel plan and obtaining of an answer to the question. Then, in a case where a plurality of combinations of the determined question and the obtained answer when determination of the question and obtaining of the answer are performed multiple times is partially similar to a plurality of combinations of the question and the answer included in the question-and-answer data stored in the storage device, the processor sends a travel plan indicated by the plan data stored in the storage device in association with the question-and-answer data as a plan to be proposed to a user to an information terminal.

### CROSS-REFERENCE TO RELATED APPLICATION

This application is based upon and claims the benefit of priority from the prior Japanese Patent Application No. 2019-159652, filed on Sep. 2, 2019, the entire contents of which are incorporated herein by reference.

### FIELD

An embodiment described here generally relates to a travel plan proposition apparatus and a travel plan proposition method for a travel plan proposition apparatus.

### BACKGROUND

A system that gathers user's answers to a plurality of questions through an interactive system and proposes a travel plan that meets user's requirements on the basis of those answers has been devised. However, it is typically necessary to gather lots of answers in order to appropriately propose a travel plan that meets user's requirements, and thus the user needs to do a very time-consuming process, which is disadvantageous. In view of such circumstances, it is desirable to be capable of proposing a travel plan while reducing a burden on a user.

### BRIEF DESCRIPTION OF THE DRAWINGS

FIG. 1 is a block diagram showing a proposition apparatus according to an embodiment.

FIG. 2 is a diagram schematically showing a configuration of a data record contained in a plan database of the proposition apparatus according to the embodiment.

FIG. 3 is a diagram schematically showing a configuration of a data record contained in a purchase contract database of the proposition apparatus according to the embodiment.

FIG. 4 is a flowchart showing information processing performed by a processor of the proposition apparatus according to the embodiment.

### DETAILED DESCRIPTION

In accordance with one embodiment, a travel plan proposition apparatus proposes a travel plan to a user of an information terminal via the information terminal. The travel plan proposition apparatus includes a communication interface, a storage device, and a processor. The communication interface communicates with the information terminal. The storage device stores question-and-answer data about the travel plan with respect to the user and plan data indicating the travel plan in association with each other. The question-and-answer data includes data regarding a plurality of combinations of a question about the travel plan to the user and an answer to the question from the user. The processor determines the question to the user by referring to the question-and-answer data stored in the storage device. The processor obtains the answer of the user to the determined question from the information terminal via the communication interface. The processor sends, in a case where a plurality of combinations of the determined question and the obtained answer when determination of the question and obtaining of the answer are performed a plurality of times is partially similar to a plurality of combinations of the question and the answer included in the question-and-answer data stored in the storage device, a travel plan indicated by the plan data stored in the storage device in association with the question-and-answer data as a plan to be proposed to the user to the information terminal via the communication interface.

Hereinafter, an embodiment will be described with reference to the drawings. It should be noted that in the embodiment, descriptions will be given by exemplifying a travel plan proposition apparatus (hereinafter, abbreviated as proposition apparatus) that offers a proposition service to propose a travel plan as a web service. In addition, the same reference signs in the drawings will denote the same or similar portions.

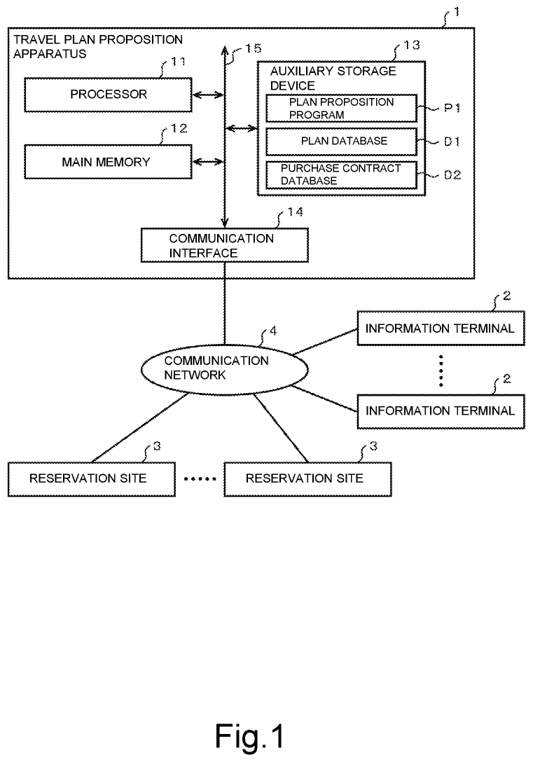

FIG. 1 shows a proposition apparatus 1 according to the embodiment. The proposition apparatus 1 is capable of communicating with information terminals 2 and reservation sites 3 via a communication network 4 as a travel reservation system. The proposition apparatus 1 is accessed by each of the information terminals 2 via the communication network 4. Accessed by the information terminal 2, the proposition apparatus 1 gathers information necessary for a travel plan from a user who operates the information terminal 2. The information necessary for a travel plan includes a travel destination, a budget, means of transportation, a schedule, and the like. Then, the proposition apparatus 1 proposes a travel plan to the user who operates the information terminal 2. Moreover, in response to the fact that the user has reserved the proposed travel plan (user's acceptance of the travel plan), the proposition apparatus 1 accesses the reservation site 3 that receives reservations of that travel plan via the communication network 4, and performs reservation processing. The travel plan includes a combination of various travel elements such as transportation, hotels, tourist sites, tourist facilities, restaurants, souvenir shops, and the like.

The travel plan may further include a time schedule of those elements. It should be noted that the proposition service may be commercial or may be non-commercial.

The information terminal 2 is a terminal device that is a user interface for a user to accept a proposed travel plan through the web service offered by the proposition apparatus 1. The information terminal 2 is an existing device having a web browsing function. The information terminal 2 is a personal computer, a tablet terminal, a smartphone, a wearable terminal, or the like for example. The reservation site 3 is a website to receive reservations of transportation, hotels, and the like associated with the travel. The communication network 4 transmits various types of data exchanged among the proposition apparatus 1, the information terminal 2, and the reservation site 3. Any one of the Internet, a virtual private network (VPN), a local area network (LAN), a public communication network, a movable object communication network, and the like can be used as the communication network 4. Alternatively, some of them can be combined and used as appropriate as the communication network 4.

The proposition apparatus 1 includes, as shown in FIG. 1, a processor 11, a main memory 12, an auxiliary storage device 13, a communication interface 14, and a transmission channel 15. A computer device for a general-purpose server for example can be used as hardware of this proposition apparatus 1. In the proposition apparatus 1, the processor 11, the main memory 12, and the auxiliary storage device 13 are connected via the transmission channel 15. In the proposition apparatus 1, a computer that performs information processing for realizing functions as the embodiment is thus configured.

The processor 11 corresponds to a central processing part of the computer. The processor 11 performs this information processing in accordance with an operating system and various information processing programs such as an application program.

The main memory 12 corresponds to a main storage part of the computer. The main memory 12 includes a nonvolatile memory area and a volatile memory area. The main memory 12 stores the information processing program in the nonvolatile memory area. In some cases, the main memory 12 stores data necessary for the processor 11 to perform various types of information processing in the nonvolatile memory area or the volatile memory area. The memory volatile area of the main memory 12 is used as a work area where data is rewritten by the processor 11 as appropriate.

The auxiliary storage device 13 corresponds to an auxiliary storage part of the computer. The auxiliary storage device 13 includes an electric erasable programmable read-only memory (EEPROM), a hard disc drive (HDD), a solid state drive (SSD), and the like for example. The auxiliary storage device 13 stores data to be used by the processor 11 for performing various types of information processing and data generated in processing of the processor 11. In some cases, the auxiliary storage device 13 stores the information processing program.

As shown in FIG. 1, the auxiliary storage device 13 stores a plan proposition program P1 as the information processing program. The plan proposition program P1 is an information processing program describing information processing for travel plan proposition to be described later. Moreover, as shown in FIG. 1, the auxiliary storage device 13 stores a plan database D1 and a purchase contract database D2. It should be noted that the plan proposition program P1, the plan database D1, or the purchase contract database D2 may be stored in the main memory 12.

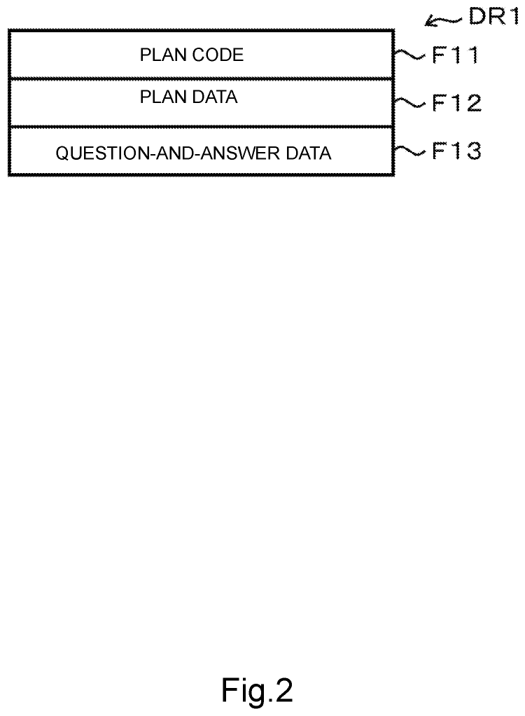

The plan database D1 is a database for managing travel plans that become candidates to be proposed. FIG. 2 schematically shows a configuration of a data record DR1 contained in the plan database D1. The plan database D1 is the collection of data records DR1. The data record DR1 shown in FIG. 2 is associated with travel plans that become candidates to be proposed. The data record DR1 includes fields F11, F12, and F13. A plan code for distinguishing an associated travel plan from other travel plans is set in the field F11. Plan data indicating the contents of the associated travel plan is set in the field F12. Question-and-answer data of the associated travel plan is set in the field F13. The question-and-answer data is data indicating a plurality of question-and-answer combinations for determining the associated travel plan as the travel plan that should be proposed (hereinafter, sometimes referred to as questions and answers). It should be noted that the data record DR1 may include another field in which arbitrary data is set in addition to the fields F11 to F13. The plan database D1 may contain plan data indicating the contents of a travel plan defined by a manager or the like who manages the proposition apparatus 1 and the data record DR1 in which the question-and-answer data indicating the questions and answers has been set. Moreover, the data record DR1 of the plan database D1 is generated by the processor 11 as will be described later.

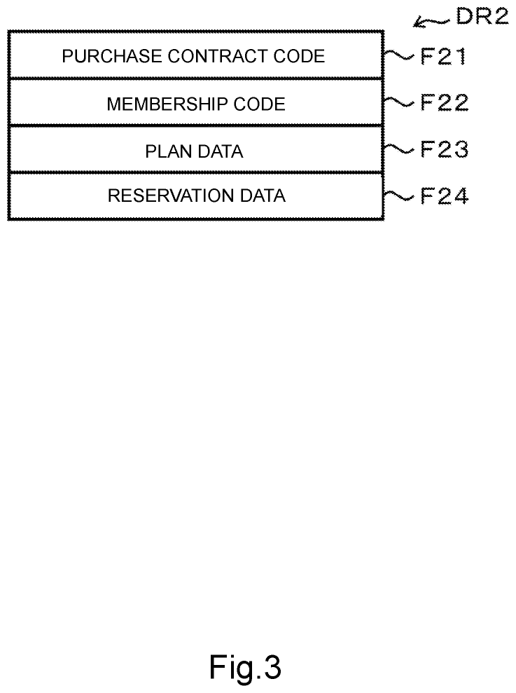

The purchase contract database D2 shown in FIG. 1 is a database for managing travel plans whose purchase contracts have been established on the basis of propositions of the proposition apparatus 1. FIG. 3 schematically shows a configuration of a data record DR2 contained in the purchase contract database D2. The purchase contract database D2 is the collection of data records DR2. The data record DR2 is associated with a travel plan whose purchase contract has been established. The data record DR2 includes fields F21, F22, F23, and F24. A purchase contract code for identifying each purchase contract is set in the field F21. A membership code for distinguishing a member who has made a purchase contract for the associated travel plan from other members is set in the field F22. Plan data indicating the associated travel plan is set in the field F23. Reservation data indicating a result of a reservation that has been made for the associated travel plan is set in the field F24. It should be noted that the data record DR2 may include another field in which arbitrary data is set in addition to the fields F21 to F24.

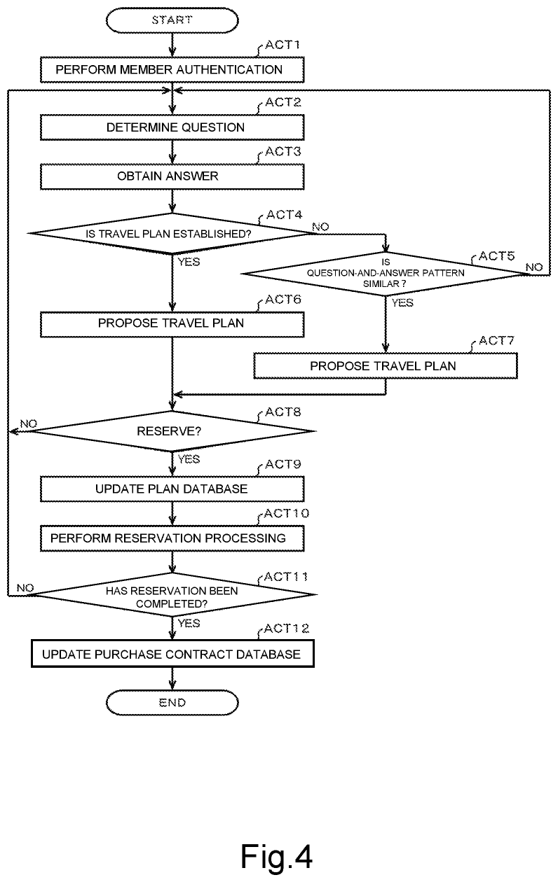

Next, an operation of the proposition apparatus 1 will be described. When the processor 11 is accessed by the information terminal 2, the processor 11 performs information processing to be described below in accordance with the information processing program stored in the main memory 12 or the auxiliary storage device 13. It should be noted that in the following descriptions of the information processing performed by the processor 11, the terms “information terminal 2” and “user” mean the information terminal 2 that has accessed the processor 11 and the user who operates that information terminal 2 respectively unless otherwise noted. FIG. 4 shows the information processing performed by the processor 11. It should be noted that the processing to be described below is an example, and the order of steps of the processing can be partially changed, some of the steps of the processing can be omitted, or another step or other steps can be added as appropriate for example.

First of all, the processor 11 performs member authentication with respect to a user in ACTT shown in FIG. 4. The processor 11 authenticates the user by using a well-known member authentication technology for example. In the embodiment, it is assumed that the proposition apparatus 1 offers the proposition service to a user registered as a member in advance. For registering the user as the member, a membership code for distinguishing from other members is determined. The membership code may be determined by the processor 11 or may be artificially determined. Then, the processor 11 writes attribute data offered by the user in association with the membership code in a member database stored in the main memory 12, the auxiliary storage device 13, or an external storage device of the proposition apparatus 1. The attribute data may include the age, sex, residential area, etc. of the user. The attribute data may include the interests and preferences, etc. of the user associated with the travel.

When the member authentication of the processor 11 succeeds, the processing of the processor 11 proceeds to ACT2. It should be noted that when the member authentication of the processor 11 fails, the processor 11 terminates information processing shown in FIG. 4. Alternatively, the processor 11 may retry member authentication when the member authentication of the processor 11 fails. In ACT2, the processor 11 determines a question to the user. For example, the processor 11 determines a question for obtaining an answer that is a reference for determining a travel plan to be proposed to the user on the basis of the attribute data written in association with the membership code of the user in the member database. The question to be determined includes questions for obtaining answers relating to a travel purpose, a destination region, a budget, means of transportation, a schedule, and the like. The existing artificial intelligence (AI) technology can be used for determining the question for example. In this manner, the processor 11 performs information processing based on the plan proposition program P1, such that the computer using the processor 11 as the central processing part functions as a determination means that determines a question.

In ACT3, the processor 11 obtains the answer of the user to the question determined in ACT2. The processor 11 sends a webpage for obtaining the answer to the question determined in ACT2 for example to the information terminal 2 via the communication interface 14. Then, the processor 11 obtains an answer notified by the information terminal 2 in accordance with a user's operation. In this manner, the processor 11 performs information processing based on the plan proposition program P1, such that the computer using the processor 11 as the central processing part functions as an obtaining means that obtains an answer.

In ACT4, the processor 11 tries to generate a travel plan on the basis of the answer obtained in ACT3. Then, the processor 11 determines whether or not the travel plan is established in this try. In other words, the processor 11 determines whether or not the travel plan has been generated as a result of the try based on the answer obtained in ACT3. For example, the processor 11 tries to generate a travel plan with a combination of elements of various travel elements included in the answer obtained in ACT3, which meet user's needs. It should be noted that the various travel elements include a move, visits to tourist facilities or tourist sites, join in an event such as a festival, a meal, stay, and the like. More specifically, the various travel elements include a visit to a place where a drama is set, shopping at a store where customers can sample wine etc., seeing a festival rite, seeing a night view, and the like. Here, the processor 11 also considers temporal elements such as a required time and a suitable time zone for each of those elements in generating the travel plan. For using facilities whose business hours are fixed for example, the time zone is set within the business hours. Moreover, for seeing the night view for example, the time zone is set in a time zone in which tourists can see a beautiful night view. The existing AI technology for example can be used for generating the travel plan. It should be noted that there is typically a low possibility that the travel plan is established as a result of the try based on only one question-and-answer. In a case where the processor 11 determines that the travel plan is not established (NO in ACT4), the processing of the processor 11 proceeds to ACT5.

In ACT5, the processor 11 determines whether or not a pattern of combinations of a question determined in ACT2 and an answer obtained in ACT3 (question-and-answer pattern) in the past is similar to a partial pattern of question-and-answer combinations indicated by any piece of question-and-answer data contained in the plan database D1. It should be noted that as will be described later, the processor 11 repeats the processing of ACT2 and ACT3 and determines in ACT5 that the question-and-answer pattern is not similar to the partial pattern of the question-and-answer combinations indicated by the any piece of the question-and-answer data contained in the plan database D1 unless a predetermined number of combinations of question and answer are obtained (NO in ACT5). Then, in a case where the processor 11 determines that the question-and-answer pattern is not similar to the partial pattern of the question-and-answer combinations indicated by the any piece of the question-and-answer data contained in the plan database D1 (NO in ACT5) and the processing of the processor 11 returns to ACT2. The processor 11 repeats the processing of ACT2 and the processing following ACT2 in a way similar to that described above. It should be noted that the processor 11 determines a question different from the question(s) determined in the past when the processor 11 performs the processing of ACT2 for the second time or later. Moreover, the processor 11 considers a plurality of answers obtained in the past when the processor 11 performs the processing of ACT4 for the second time or later. Moreover, the processor 11 considers a plurality of combinations of the determined questions and the obtained answers in the past when the processor 11 performs the processing of ACT5 for the second time or later. Then, the processor 11 compares a plurality of such question-and-answer patterns with the partial pattern of the question-and-answer combinations indicated by the any piece of the question-and-answer data contained in the plan database D1, to thereby determine whether or not those are similar to each other. The existing matching technology or AI technology for example can be used for this determination.

The processor 11 considers an answer newly obtained in ACT3 in addition to the answers obtained in the past. Then, in a case where the processor 11 determines that the travel plan that should be proposed has been established (YES in ACT4), the processing of the processor 11 proceeds to ACT6. In ACT6, the processor 11 should output the travel plan to the information terminal 2 in order to propose the established travel plan, i.e., the travel plan generated as a result of the try to the user. That is, the processor 11 sends a webpage showing the contents of the established travel plan to the information terminal 2 via the communication interface 14 in order to cause the information terminal 2 to display the webpage for example. It should be noted that the processor 11 includes in the webpage a graphical user interface (GUI) object for causing the user to designate whether to reserve (accept) the proposed travel plan or reject it. The information terminal 2 causes the display device to display the webpage and waits for the user's specification of whether to reserve the travel plan or reject it. Then, when the information terminal 2 receives the specification to reserve or reject the travel plan, which is made by the user operating the GUI object, the information terminal 2 notifies the proposition apparatus 1 of the contents of the specification. The processor 11 of the proposition apparatus 1 receives the notice via the communication interface 14.

On the other hand, in a case where the processor 11 determines that the travel plan that should be proposed is not established even after considering the answers in the past (YES in ACT4), the processing of the processor 11 proceeds to ACT5 as described above. Then, in a case where the processor 11 determines that the pattern of the combinations of the question determined in ACT2 and the answer obtained in ACT3 in the past is similar to the partial pattern of the question-and-answer combinations indicated by the any piece of the question-and-answer data contained in the plan database D1 (YES in ACT5), the processing of the processor 11 proceeds to ACT7. In ACT7, the processor 11 outputs a travel plan to the information terminal 2 in order to propose the travel plan in a way similar to that of ACT6. That is, the processor 11 causes the information terminal 2 to display a webpage showing the contents of the travel plan for example. Here, the processor 11 sets a travel plan associated with the question-and-answer data including the question-and-answer combinations whose pattern is similar to the pattern of the combinations of the question determined in ACT2 and the answer obtained in ACT3 in the past is an object to be proposed. The processor 11 retrieves the data record DR1 in which the corresponding question-and-answer data is set in the field F13 for example from the plan database D1. Then, the processor 11 sets a travel plan indicated by the plan data set in the field F12 of the corresponding data record DR1 as an object to be proposed.

The output of the webpage showing the travel plan by the processor 11 for causing the information terminal 2 to display it in ACT6 or ACT7 corresponds to the output of the travel plan as a plan to be proposed to the user. In this manner, the processor 11 performs information processing based on the plan proposition program P1, such that the computer using the processor 11 as the central processing part functions as an output means.

After the processor 11 proposes the travel plan in ACT6 or ACT7, the processing of the processor 11 proceeds to ACT8. In ACT8, the processor 11 determines whether or not reservation of the proposed travel plan has been designated. The user designates reservation of the travel plan (acceptance of the travel plan) or rejection of the travel plan on the webpage displayed on the information terminal 2. Then, when the user designates rejection of the travel plan on the webpage that proposes the travel plan, the information terminal 2 notifies the proposition apparatus 1 of the fact. When the processor 11 receives the notice from the information terminal 2 via the communication interface 14, the processor 11 determines that reservation (acceptance) of the proposed travel plan has not been designated (NO in ACT8). Then, in this case, the processor 11 repeats the processing of ACT2 and the processing following ACT2 in a way similar to that described above.

On the other hand, when the user designates reservation on the webpage that proposes the travel plan, the information terminal 2 notifies the proposition apparatus 1 of the fact. When the processor 11 receives the notice from the information terminal 2 via the communication interface 14, the processor 11 determines that reservation of the proposed travel plan has been designated (YES in ACT8). Then, in this case, the processing of the processor 11 proceeds to ACT9. In ACT9, the processor 11 updates the plan database D1. The processor 11 generates new data record DR1 for example and updates the plan database D1 to include this data record DR1. The processor 11 sets a plan code determined not to overlap the plan code set in the field F11 of the existing data record DR1 in the field F11 of the new data record DR1. The processor 11 sets plan data indicating a travel plan proposed in ACT6 or ACTT in the field F12 of the new data record DR1. The processor 11 sets, in the field F13 of the new data record DR1, question-and-answer data indicating a plurality of questions and answers made by repeating the processing of ACT2 and ACT3 multiple times during execution of information processing shown in FIG. 4. In this manner, the processor 11 causes the auxiliary storage device 13 to store the plan data regarding the travel plan accepted by the user and the question-and-answer data indicating the questions and answers on the basis of which that travel plan has been selected as a candidate to be proposed. In this manner, the processor 11 performs information processing based on the plan proposition program P1, such that the computer using the processor 11 as the central processing part functions as a learning means.

In ACT10, the processor 11 performs reservation processing. That is, the processor 11 performs reservation processing for the use according to the travel plan for an element of the elements that constitute the proposed travel plan in ACT6 or ACTT, whose reservation has been received by the reservation site 3 on which an online procedure from the proposition apparatus 1 via the communication network 4 is permitted. For example, the processor 11 accesses the reservation site 3 that has received a reservation for a reserved seat of a train and performs reservation processing for the reserved seat of the train, which has been determined to be used in that travel plan. Moreover, for example, the processor 11 accesses the reservation site 3 that has received a reservation for stay in a hotel and performs reservation processing on the hotel determined to be used in the travel plan. It should be noted that in a case where the user has offered personal information necessary for reservations in association with the member registration and the personal information has been written in the member database, the processor 11 uses the personal information for reservation processing. In a case where the personal information has not been written in the member database, the processor 11 sends a webpage for designating necessary personal information to the information terminal 2 via the communication interface 14 in order to cause the information terminal 2 to display the webpage. Then, the processor 11 obtains the personal information designated by the user on this webpage from the information terminal 2 via the communication interface 14. The personal information includes the name, age, address, credit card information, and the like. It should be noted that regarding an element that cannot be reserved through the online procedure from the proposition apparatus 1, the processor 11 sends a webpage for guiding the user to make a reservation to the information terminal 2 via the communication interface in order to cause the information terminal 2 to display the webpage.

In ACT11, the processor 11 determines whether or not the reservation in the reservation processing has been completed. The processor 11 repeats the processing of ACT2 and the processing following ACT2 in a way similar to that described above in a case where the processor 11 determines that the reservation has not been completed for all elements of the elements determined to be used in the travel plan, which are objects to be reserved in the reservation processing (NO in ACT11). It should be noted that only in a case where a travel plan different from the travel plans proposed in ACT6 or ACTT in the past has been found in ACT4 or ACT5 during repetition of the processing of ACT2 and the processing following ACT2, the processor 11 makes a YES determination as shown in FIG. 4 described above. That is, the processor 11 continues question-and-answer and searches for a new travel plan that should be proposed. Then, in a case where regarding the proposed travel plan, the processor 11 determines that the reservation in reservation processing in ACT10 has been completed (YES in ACT11), the processing of the processor 11 proceeds to ACT12.

In ACT12, the processor 11 updates the purchase contract database D2. The processor 11 creates a new data record DR2 for example and updates the purchase contract database D2 to include this data record DR2. The processor 11 sets a purchase contract code determined not to overlap the purchase contract code set in the field F21 of the existing data record DR2 in the field F21 of the new data record DR2. The processor 11 sets the membership code obtained in ACTT in the field F22 of the new data record DR2. The processor 11 sets the plan data indicating the proposed travel plan in ACT6 or ACTT in the field F23 of the new data record DR2. The processor 11 sets reservation data generated to show the result of reservation processing in ACT10 in the field F24 of the new data record DR2. The processor 11 includes a reservation code issued from the reservation site 3 in the reservation data in order to identify the reservation for example. Accordingly, management for the travel plan on which the purchase contract has made at this time becomes possible by referring to the purchase contract database D2. Then, the processor 11 terminates the information processing shown in FIG. 4 when the processor 11 finishes updating the purchase contract database D2.

As described above, in a case where the plan database D1 contains question-and-answer data indicating questions and answers including some of the questions and answers whose pattern is similar to a pattern of the questions and answers in the past even in a situation where a travel plan is not established only on the basis of questions and answers to/from the user, the proposition apparatus 1 proposes a travel plan indicated by the plan data associated with the corresponding question-and-answer data to the user. Therefore, it is possible to propose a travel plan to the user without the need for repeating question-and-answer until the travel plan is established. Then, in a case where the user accepts the travel plan, the user does not need to repeat question-and-answer thereafter. Therefore, it is possible to propose a travel plan while reducing a burden on a user.

Moreover, in a case where the user has accepted the proposed travel plan, the proposition apparatus 1 causes the plan database D1 to store the question-and-answer data indicating the questions and answers considered for selecting the travel plan as an object to be proposed in association with the plan data of that travel plan. Therefore, in a case where the questions and answers in the pattern similar to that of the questions and answers at this time are performed thereafter, the travel plan can be proposed in a similar way.

Various modifications of the above-mentioned embodiment as follows can be made. The data record DR1 of the plan database D1 may include data regarding attributes of the user. Then, the processor 11 may consider similarity between the attributes of the user and attributes of answerers of the questions and answers whose pattern is to be compared with the questions and answers of that user in ACT5 of FIG. 4. For example, in a case where a plurality of questions and answers whose pattern is similar to that of the questions and answers of the user is found, the processor 11 may select questions and answers with respect to an answerer having attributes closer to those of the user from among those questions and answers as a candidate to be proposed.

Either one or both of the plan database D1 and the purchase contract database D2 may be stored in the storage device provided outside the proposition apparatus 1.

The processor 11 may offer the proposition service to a non-member by omitting the member authentication in ACT1 or authenticating even a user who has not been registered as the member as a guest in ACT1.

The functions of the travel plan proposition apparatus 1 may be realized by being shared and processed by a plurality of information processing apparatuses. For example, the reservation processing as ACT10 of FIG. 4 and the other processing in FIG. 4 may be performed by separate information processing apparatuses linked to each other.

Some of or all of the functions realized by the processor 11 in the information processing may also be realized through hardware that performs information processing not based on the program such as a logic circuit. Moreover, each of those functions may also be realized by combining software control with the hardware such as the logic circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A travel plan proposition apparatus that proposes a travel plan to a user of an information terminal via the information terminal, comprising:
a communication interface that communicates with the information terminal;
a storage device that stores question-and-answer data about the travel plan with respect to the user and plan data indicating the travel plan in association with each other, the question-and-answer data including data regarding a plurality of combinations of a question about the travel plan to the user and an answer to the question from the user; and
a processor that
determines the question to the user by referring to the question-and-answer data stored in the storage device,
obtains the answer of the user to the determined question from the information terminal via the communication interface, and
sends in a case where a plurality of combinations of the determined question and the obtained answer when determination of the question and obtaining of the answer are performed multiple times is partially similar to a plurality of combinations of the question and the answer included in the question-and-answer data stored in the storage device, a travel plan indicated by the plan data stored in the storage device in association with the question-and-answer data as a plan to be proposed to the user to the information terminal via the communication interface.

2. The travel plan proposition apparatus according to claim 1, wherein
the processor determines a question for obtaining an answer that becomes a reference for determining the travel plan to be proposed to the user.

3. The travel plan proposition apparatus according to claim 2, wherein
the processor
obtains an attribute of the user and
determines a question to the user on a basis of the obtained attribute data.

4. The travel plan proposition apparatus according to claim 1, wherein
the processor sends a webpage for obtaining an answer to the determined question to an information terminal via the communication interface.

5. The travel plan proposition apparatus according to claim 1, wherein
the processor
tries to generate a travel plan that meets user's needs included in the answer to the question,
determines whether or not the travel plan is established as a result of the try, and
in a case where the processor determines that the travel plan is not established as the result of the try, compares a plurality of combinations of the question and the answer with a plurality of combinations of the question and the answer included in the question-and-answer data stored in the storage device.

6. The travel plan proposition apparatus according to claim 5, wherein
the processor sends, in a case where the processor determines as a result of the comparison that the plurality of combinations of the determined question and the obtained answer is partially similar to the plurality of combinations of the question and the answer included in the question-and-answer data stored in the storage device, the travel plan indicated by the plan data stored in the storage device in association with the question-and-answer data as the plan to be proposed to the user to the information terminal via the communication interface.

7. The travel plan proposition apparatus according to claim 5, wherein
the processor performs processing of determination of the question and obtaining of the answer again in a case where the processor determines as a result of the comparison that the plurality of combinations of the determined question and the obtained answer is not similar to the plurality of combinations of the question and the answer included in the question-and-answer data stored in the storage device.

8. The travel plan proposition apparatus according to claim 1, wherein
the processor performs processing of determination of the question and obtaining of the answer again in a case where the processor receives a notice from the information terminal via the communication interface, the notice indicating that the user has rejected the travel plan sent as the plan to be proposed to the user to the information terminal.

9. The travel plan proposition apparatus according to claim 1, wherein
the processor causes the storage device to store in a case where the processor receives a notice from the information terminal via the communication interface, the question-and-answer data including the plurality of combinations of the determined question and the obtained answer and the plan data indicated by the travel plan sent as the plan to be proposed to the user to the information terminal in association with each other, the notice indicating that the user has accepted the travel plan sent as the plan to be proposed to the user to the information terminal.

10. A travel plan proposition method for a travel plan proposition apparatus that proposes a travel plan to a user of an information terminal via the information terminal, comprising:
storing question-and-answer data about the travel plan with respect to the user and plan data indicating the travel plan in association with each other, the question-and-answer data including data regarding a plurality of combinations of the question about the travel plan to the user and an answer to the question from the user; and
determining the question to the user by referring to the question-and-answer data stored in the storage device, obtaining the answer of the user to the determined question from the information terminal via the communication interface, and sending in a case where a plurality of combinations of the determined question and the obtained answer when determination of the question and obtaining of the answer are performed multiple times are partially similar to a plurality of combinations of the question and the answer included in the question-and-answer data stored in the storage device, a travel plan indicated by the plan data stored in the storage device in association with the question-and-answer data as a plan to be proposed to the user to the information terminal via the communication interface.
